(19) United States
(12) Patent Application Publication
(10) Pub. No.: US 2019/0149258 A1
(43) Pub. Date: May 16, 2019

(54) TRANSMISSION AND RECEPTION APPARATUS, OPTICAL TRANSMISSION APPARATUS AND OPTIMIZATION METHOD FOR PLUGGABLE INTERFACE

(71) Applicant: FUJITSU LIMITED, Kawasaki-shi (JP)

(72) Inventors: Hirofumi Araki, Kawasaki (JP); Hisayuki Ojima, Kawasaki (JP); Yasushi YOSHINO, Kawasaki (JP); Satoru Saitoh, Kawasaki (JP); KAZUYA IKEDA, Kawasaki (JP); TAICHI ISHIKAWA, Funabashi (JP)

(73) Assignee: FUJITSU LIMITED, Kawasaki-shi (JP)

(21) Appl. No.: 16/191,696

(22) Filed: Nov. 15, 2018

(30) Foreign Application Priority Data
Nov. 16, 2017 (JP) 2017-220986

(51) Int. Cl. H04J 14/02; H04B 10/079

(52) U.S. Cl. CPC H04J 14/0201; H04B 10/07957; H04J 14/0278

(57) ABSTRACT

A transmission and reception apparatus, includes a processor and a processing device coupled to the processor, wherein the processor is configured to detect insertion of a pluggable module, issue, when the insertion of the pluggable module is detected, an instruction to the processing device to generate a first test signal to be supplied to the pluggable module, extract an alternating current component from a first monitoring result of the first test signal by the pluggable module and acquiring pulse width information at a plurality of phase points, and set a phase point determined based on the pulse width information as an optimum phase value to the processing device.

### CROSS-REFERENCE TO RELATED APPLICATION

This application is based upon and claims the benefit of priority of the prior Japanese Patent Application No. 2017-220986, filed on Nov. 16, 2017, the entire contents of which are incorporated herein by reference.

### FIELD

The embodiments discussed herein are related to a transmission and reception apparatus, an optical transmission apparatus and an optimization method for a pluggable interface.

### BACKGROUND

Further increase in capacity and speed of an optical transmission network is demanded together with traffic expansion of communication equipment, popularization of internet of things (IoT), progress of the cloud technology and so forth.

Examples of the related art include Japanese Laid-open Patent Publication No. 8-181662 and Japanese Laid-open Patent Publication No. 2002-368692.

### SUMMARY

According to an aspect of the embodiments, a transmission and reception apparatus, includes: a processor; and a processing device coupled to the processor, wherein the processor is configured to: detect insertion of a pluggable module, issue, when the insertion of the pluggable module is detected, an instruction to the processing device to generate a first test signal to be supplied to the pluggable module; extract an alternating current component from a first monitoring result of the first test signal by the pluggable module and acquiring pulse width information at a plurality of phase points; and set a phase point determined based on the pulse width information as an optimum phase value to the processing device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts an example of a transponder;

FIGS. 2A and 2B depict an example of a pluggable module and a digital processing device;

FIG. 3 depicts an example of a wavelength division multiplexing (WDM) system;

FIG. 4 depicts an example of an optical transmission apparatus;

FIG. 5 depicts another example of a pluggable module and a digital processing device;

FIG. 6 depicts another example of a transponder;

FIG. 7 depicts an example of an optimization process for a pluggable interface;

FIG. 8 depicts an example of calculation of a phase optimum value;

FIG. 9 depicts an example of a phase difference pulse (comparison result) and an integral value pulse when a phase difference is zero;

FIG. 10 depicts an example of a phase difference pulse (comparison result) and an integral value pulse when a phase difference is 1/10 of a cycle;

FIG. 11 depicts an example of a relationship between a phase difference pulse (comparison result) and an integral value pulse when a phase difference is 2/10 of a cycle;

FIG. 12 depicts an example of a plot of a peak value of an integral value as a function of a phase difference;

FIG. 13 depicts an example of an inclination of an integral value peak between two points when a phase difference is varied;

FIG. 14 depicts an example of a processing flow; and

FIG. 15 depicts another example of a processing flow.

### DESCRIPTION OF EMBODIMENTS

For example, a digital coherent signal processing technology is adopted by an optical transmission apparatus to increase the transmission speed per one wavelength from 100 to 200 Gbps or more. For example, by multiplexing optical signals of multi-channels using an optical wavelength division multiplexing technology (WDM), the maximum transmission capacity per one fiber is increased. For example, a transponder is used as a relay interface for converting a client signal into an optical signal having a wavelength suitable for wavelength division multiplexing.

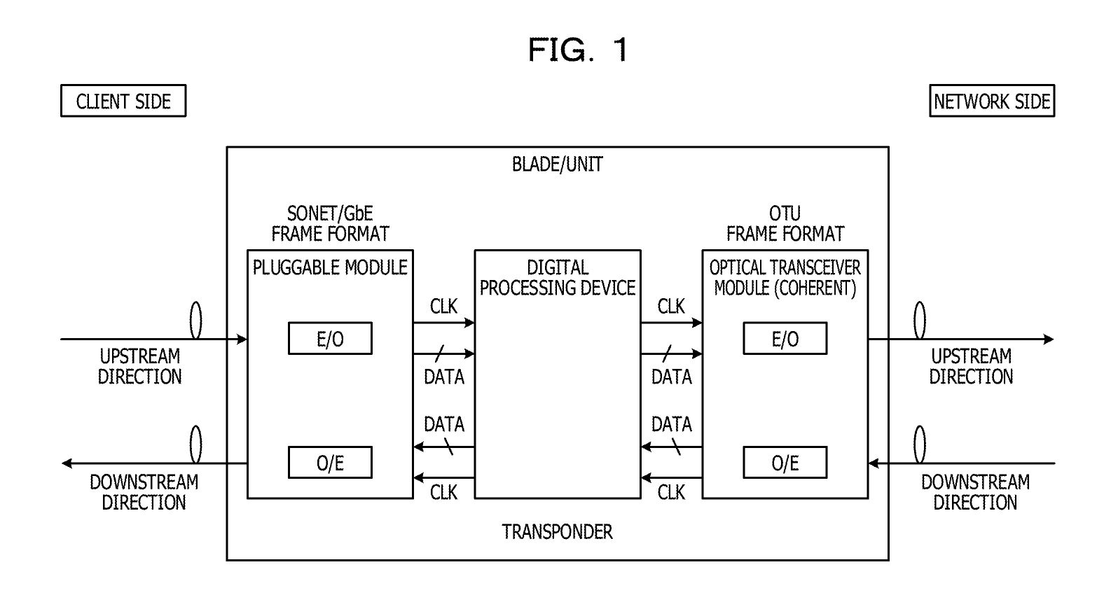

FIG. 1 depicts an example of a transponder. The transponder is provided in an optical network node (optical transmission apparatus) in such a form that it includes a blade, a plugin unit (plug-in unit (PIU)), a rack unit and so forth. As a client side interface of a transponder, a pluggable interface module is used. In the upstream direction, an optical signal received from a client apparatus such as a rooter is converted into an electric signal by a pluggable module and is outputted to a digital processing device. The digital processing device applies a frame process or an error correction process to a client signal of a synchronous optical network (SONET), a gigabit Ethernet (GbE) or the like. The digitally processed signal is subjected to electrical-to-optical conversion by a coherent optical transceiver module, and the resulting electric signal is outputted from the transponder and is wavelength division multiplexed with an optical signal from a different transponder. In the downstream direction, a process in the reverse direction is performed. For example, a coherent optical transceiver module on the network side may be set to a pluggable state.

For example, an optical transmission apparatus compensates for a level deviation between optical signals, a level deviation between wavelengths or the like.

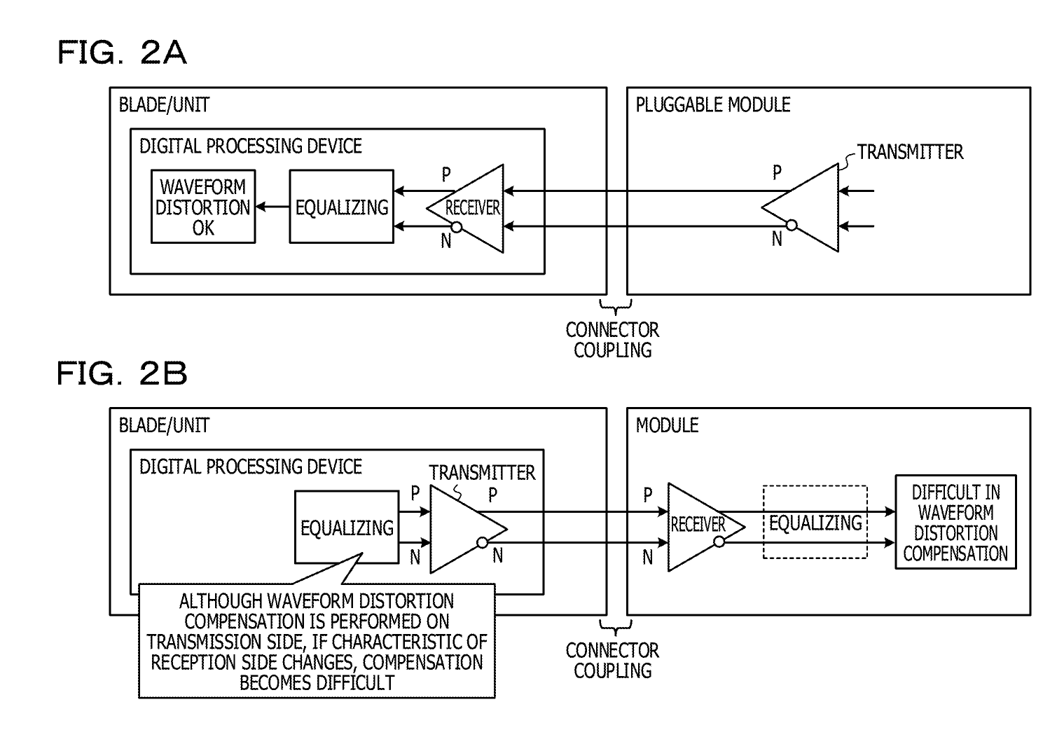

By downsizing of a pluggable module and increase of the speed of an electric signal, a clock data recovery (CDR) built in a pluggable module is omitted. Therefore, wavelength degradation by a high-speed electric signal is not corrected by the pluggable module side. FIGS. 2A and 2B depict an example of a pluggable module and a digital processing device. As depicted in FIG. 2A, for an electric signal inputted from a pluggable module to a blade or a digital signal device on a unit, equalizing or the like is performed by a digital processing device on the reception side to correct waveform distortion. Since a waveform distortion compensation circuit is provided on the reception side, the reception side may cope with waveform distortion whichever performance or characteristic the pluggable module used has.

As depicted in FIG. 2B, for an electric signal inputted from a digital processing device to a pluggable module, waveform distortion correction is performed by a digital processing device on the transmission side because the reception side includes no waveform distortion compensation function. In this case, a pluggable module capable of being used is limited to a module that is compatible with a distortion compensation function set to the digital processing device.

While a pluggable module may be freely inserted and exchanged, it is difficult to use a pluggable module if the pluggable module is not a product of a specific manufacturer or if the pluggable module does not have a specific serial number due to quality dispersion in a manufacturer. In the case where a pluggable module is not compatible with distortion compensation function of a digital processing device, a phase difference by connector coupling, a phase difference by wiring, reflection and so forth have a remarkable influence on the pluggable module.

For example, the signal waveform may be optimized by a transmission and reception apparatus that uses a pluggable interface.

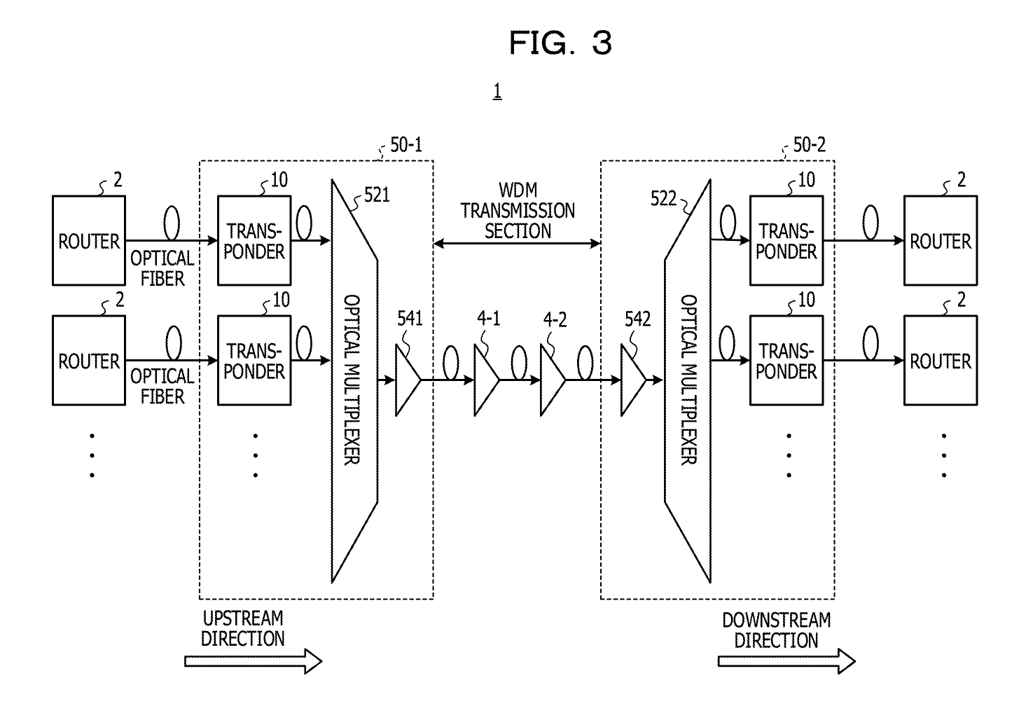

FIG. 3 depicts an example of a WDM system. In a WDM system 1, optical transmission apparatus 50-1 and 50-2 are coupled to each other through an optical transmission path 3. Each of the optical transmission apparatus 50-1 and 50-2 includes a plurality of transponders 10. Each transponder 10 is an example of a transmission and reception apparatus. While the optical transmission apparatus 50-1 and 50-2 are depicted as the transmission side and the reception side in FIG. 3, respectively, for the convenience of illustration, the optical transmission apparatus 50-1 and 50-2 individually have a bidirectional functional configuration for transmission and reception.

In the optical transmission apparatus 50-1, a signal from a transfer node such as a router or an optical switch (hereinafter referred to collectively as “router 2”) is optical wavelength converted by a transmission unit of each transponder 10. The optical wavelength converted signals are wavelength division multiplexed by an optical multiplexer 521 and is amplified by an optical amplifier 541 and then is transmitted over a long distance. On the optical transmission path 3, amplifier nodes 4-1 and 4-2 are disposed and amplify an attenuated optical signal. The optical signal transmitted over the long distance and received by the optical transmission apparatus 50-1 is wavelength demultiplexed by an optical demultiplexer 522 after the power thereof is amplified by an optical amplifier 542. The optical signal is received by a reception unit of the transponder 10 after the optical wavelength demultiplexing and then is transmitted to the router 2.

If a pluggable module is used for an interface on the client side of the transponder 10, a characteristic and/or quality are dispersed for each manufacturer or each product and the distortion compensation function the digital processing device of the transponder 10 has may not be practically used fully. Also in the case where a coherent optical transceiver on the network side of the transponder 10 is made pluggable, a similar problem may occur.

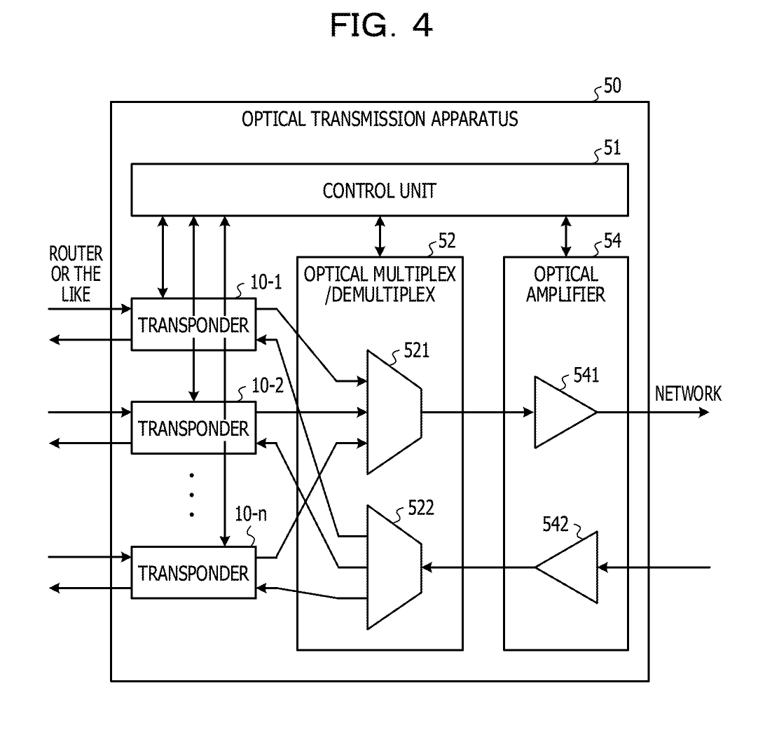

FIG. 4 depicts an example of an optical transmission apparatus. As described hereinabove with reference to FIG. 3, the optical transmission apparatus 50 includes transponders 10-1 to 10-n (each hereinafter referred to suitably as “transponder 10”), an optical multiplexer/demultiplexer 52, an optical amplifier 54 and a control unit 51. A plurality of optical transmission apparatus 50 having such a configuration as described above are disposed and coupled to each other by a transmission path of optical fiber or the like to form the WDM network of FIG. 3. While, in the configuration example of FIGS. 3 and 4, all wavelengths are added and dropped by the optical transmission apparatus 50 (or 50-1 and 50-2), an optical switch for adding, dropping or passing an arbitrary wavelength may be provided. Also in this case, it is sometimes difficult to make full use of distortion compensation of a digital processing device due to a dispersion in performance or characteristic of the pluggable module used in the transponders 10.

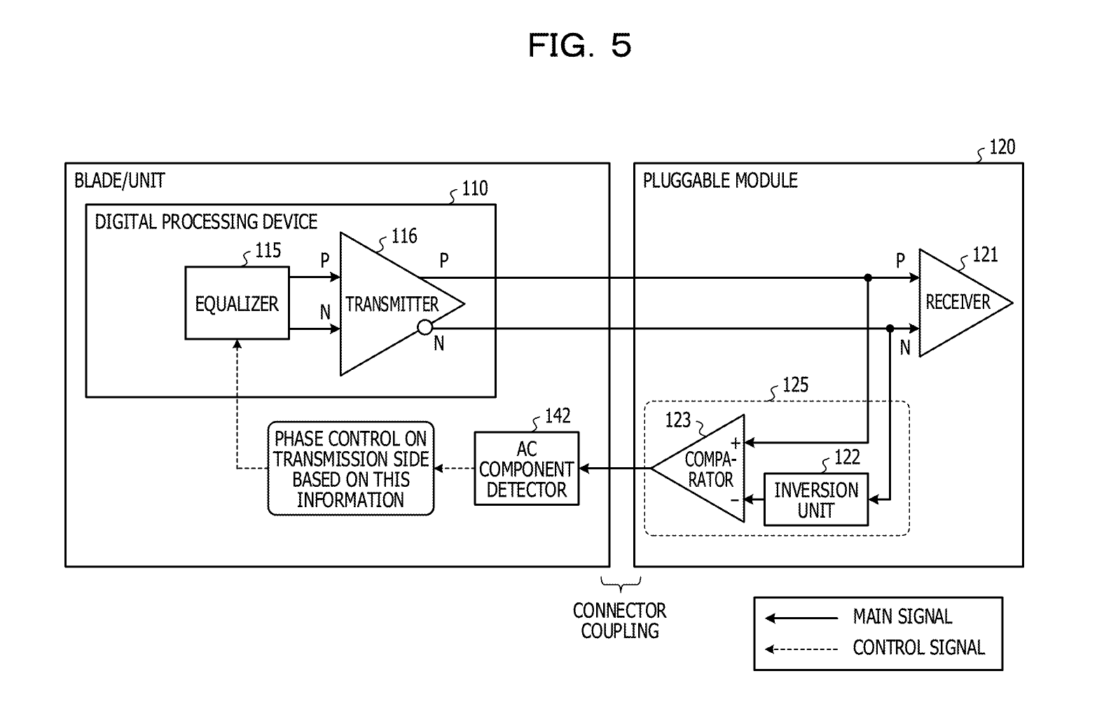

FIG. 5 depicts an example of optimization of a pluggable interface. A pluggable module 120 is electrically coupled to a blade/unit (in FIG. 5, referred to as “Blade/Unit”) by connector coupling. The blade/unit is a main body of a transmission and reception apparatus. Waveform distortion of differential signals is compensated for by an equalizer 115 of a digital processing device 110 incorporated in the blade/unit, and a positive phase signal (P) and a negative phase signal (N) are outputted from a transmitter 116. The electric signals whose waveform distortion is compensated for are received by a receiver 121 of the pluggable module 120. If a performance and/or a characteristic of the pluggable module 120 differ depending upon a manufacturer or a production line, it is difficult to satisfy a prescribed signal characteristic regardless of the waveform distortion compensation by the equalizer 115.

An electric signal that is supplied from the digital processing device 110 to the pluggable module 120 is high-speed (for example, 28 Gbps) differential signals. In the case where it is difficult to make effective use of the compensation for waveform distortion of the digital processing device 110, an influence of the phase difference between the P signal and the N signal of the high-speed differential signals (hereinafter referred to as “P/N skew”) appears remarkably on the deception side.

It is conceivable, in order to compensate for the P/N skew, to provide a configuration that includes a monitor circuit 125 for monitoring the P/N skew, which is provided on the reception side of the pluggable module such that a result of monitoring by the monitor circuit 125 is fed back to the blade/unit side to compensate for the P/N skew by an equalizer 115 on the transmission side.

The monitor circuit 125 includes an inverter 122 and a comparator 123, and one of the P signal and the N signal (in the example of FIG. 5, the N signal) is inputted to the inverter 122, by which the phase thereof is inverted. The inverted signal (inverted signal of the N signal) is coupled to one of inputs of the comparator 123. The other signal of the differential signals (in the example of FIG. 5, the P signal) is coupled to the other one of the inputs of the comparator 123. A phase difference between the two input signals is outputted from the comparator 123.

An AC (alternating current) component is detected from the output of the comparator 123 by an AC component detector 142 on the blade/unit side. The detected AC component represents an amount of the P/N skew of the differential signals. Waveform distortion is corrected by the equalizer 115 based on the detected AC component.

However, as described above, the electric signal is a high-speed signal of 28 Gbps or the like and the numerical value of the phase difference between P and N is that of a picosecond order. The timing at which the phases of the two signals are compared with each other is severe, and a high-price and large-size circuit device may be used for fine adjustment of the phase with high accuracy. This is contrary to the request for downsizing of a pluggable module.

Therefore, in the embodiment, a configuration described below is adopted to optimize the electric signal waveform between the blade/unit side and the pluggable module without increasing the size of the circuit.

(1) A test pattern for phase comparison is transmitted using a signal of a frequency lower than an actual operation frequency of the digital processing device 110.

(2) The low-speed test pattern is monitored and the phases of the P and N signals are compared with each other.

(3) An AC component is extracted from a result of phase comparison and pulse width information is extracted as a function of the phase difference from the AC component.

(4) A phase difference (control value) at a point at which the pulse width is in the minimum is determined from the extracted pulse width information.

(5) The determined phase difference (control value) is set to the digital processing device 110 to optimize the electric signal waveform in response to a pluggable module to be used.

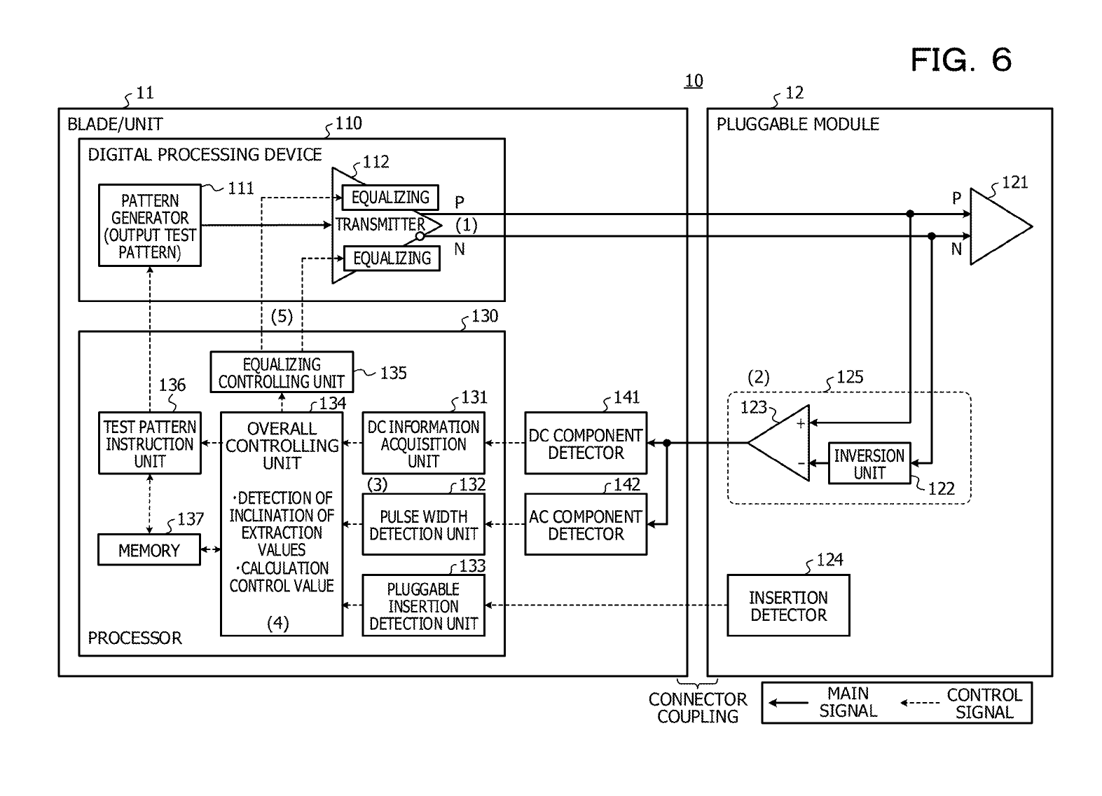

FIG. 6 depicts an example of a configuration of a transponder 10 that implements the configuration described above. The transponder 10 includes an apparatus main body in the form of the blade or plugin unit 11 (hereinafter referred to simply as “blade 11”) and a pluggable module 12. The pluggable module 12 is, for example, an optical communication interface with the client side or the network side and is electrically coupled to the blade 11 by connector coupling. [0025] A digital processing device 110, a processor 130, a direct current (DC) component detector 141 and an AC component detector 142 are disposed on the blade 11. The digital processing device 110 includes a pattern generator 111 and a transmitter 112 that has an equalizing function. As depicted in FIG. 5, the equalizer may be provided as a circuit separate from a transmission block. In any case, characteristics of the P signal and the N signal of the differential signals are controlled individually. The processor 130 includes a DC information acquisition unit 131, a pulse width detection unit 132, a pluggable insertion detection unit 133, an overall controlling unit 134, an equalizing controlling unit 135, a test pattern instruction unit 136 and a memory 137.

The pluggable module 12 includes a receiver 121, an insertion detector 124 and a monitor circuit 125. The monitor circuit 125 includes an inverter 122 and a comparator 123. If the pluggable module 12 is inserted into the blade 11, the insertion detector 124 detects completion of insertion based on an insertion pressure, a signal communication level or the like and issues a notification of insertion completion or completion of activation to the blade 11 side. If the insertion of the pluggable module 12 is completed, optimization is performed on the electric signal waveform between the apparatus main body (for example, blade 11) and the pluggable module 12 before operation of the service. Operation of the optimization is described below.

<Operation (1): Transmission of Test Pattern>

If the overall controlling unit 134 of the processor 130 receives a report of insertion completion of the pluggable module 12 from the pluggable insertion detection unit 133, a test pattern is driven to start a process for waveform distortion compensation. After the waveform distortion compensation process is started, the test pattern instruction unit 136 outputs a test pattern creation instruction to the pattern generator 111 of the digital processing device 110. The pattern generator 111 outputs a test pattern based on the test pattern creation instruction. As an example of the test pattern, a repeat pattern of a same signal like a low-speed clock signal is used.

The transmitter 112 produces an inverted signal from the test pattern and differentially outputs a P signal and an N signal. The transmitter 112 may variably set the magnitude (absolute value) of the phase difference between the P and N signals within a range of 0 to 2n (radians) and outputs differential signals to the pluggable module 12 while changing the phase difference. The phase difference between the P and N signals may be set variably, for example, by fixing the phase of one of the signals and displacing the phase of the other one of the signals.

<Operation (2): Phase Comparison>

Part of the differential signals to be inputted to the receiver 121 of the pluggable module 12 are branched and monitored by the monitor circuit 125. In the monitor circuit 125, the phase of one of the differential signals (for example, the N signal) is inverted by the inverter 122. The comparator 123 compares the phase of the signal after the phase invert and the phase of the other one of the differential signals (for example, the P signal) and outputs a result of the comparison. The output of the comparator 123 includes information of the phase difference between P and N of the received test signals.

<Operation (3): Extraction of Pulse Width Information>

The output of the comparator 123 is supplied to the AC component detector 142 of the blade 11. A result of detection by the AC component detector 142 is supplied to the pulse width detection unit 132 of the processor 130. The pulse width detection unit 132 detects pulse width information from the AC component information for each variable phase difference. In this example, a peak value of a time integral value of the phase difference pulse is detected as the pulse width information. Details of detection of an integral value peak are hereinafter described. The detected pulse width (peak value of the integral value) is inputted to the overall controlling unit 134 together with the corresponding phase difference.

While the DC component detector 141 and the DC information acquisition unit 131 may not essentially be required for basic operation of the transponder 10, the amplitude level of the differential signals may be optimized by using information of a DC (direct current) component. In this case, a test signal of a fixed level is transmitted in place of a repetitive test pattern like an alternating signal, and the DC component is detected by the DC component detector 141. The detected DC component is inputted to the DC information acquisition unit 131 and is used for amplitude control of the differential signals. As a result, the signal received by the pluggable module 12 is a signal that is optimized in phase, and beside, in amplitude. Also this DC control is hereinafter described.

<Operation (4): Calculation of Control Value>

The overall controlling unit 134 acquires an integral peak value of the phase difference pulse for each variable phase and successively stores the acquired values into a memory 137. The overall controlling unit 134 uses part of the memory 137 as a work area to determine the integral peak value of the phase difference pulse as a function of a given phase difference and determines a phase difference at a point at which the pulse width of the phase difference pulse is minimized. As an example, a point of intersection at a valley between two line segments whose inclinations are directed in the opposite directions to each other is determined from data of the integral value peak values of the phase difference pulse, and the phase difference at the point of intersection is specified. The phase difference at this time is a control value that minimizes the waveform distortion.

<Operation (5): Setting of Control Value>

The overall controlling unit 134 outputs the control value to the equalizing controlling unit 135. The equalizing controlling unit 135 sets the control value (for example, the phase of the target) to the digital processing device 110. Thereafter, as the digital processing device 110 operates with the set value, it may optimize the waveform of an electric signal to be processed by the pluggable module 12. After the optimization of the signal waveform is completed, transmission and reception of a normal data signal are started. Changeover means such as a selector or a switch may be used to perform changeover between the output of the pattern generator 111 and the output of the signal generator that is used during practical use such that, after the optimization process for the signal waveform ends, the output of the signal generator is coupled to the input of the transmitter 112.

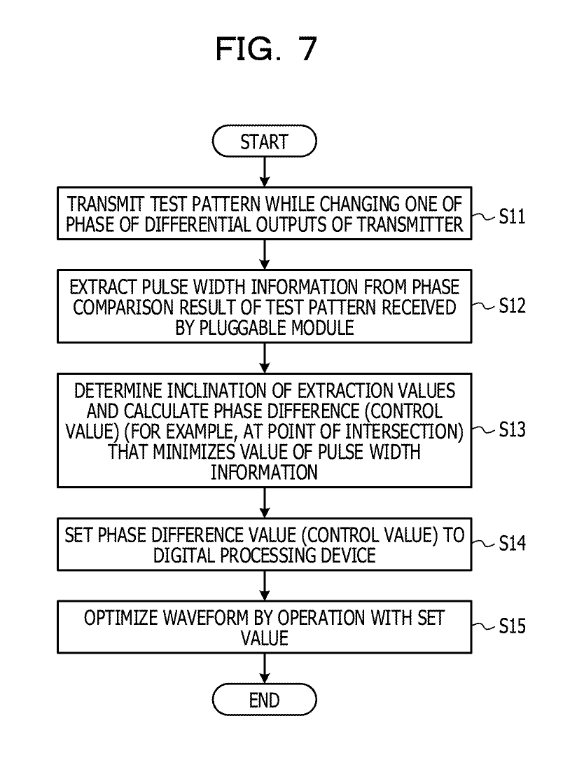

FIG. 7 depicts an example of an optimization process for a pluggable interface. Before practical use, the digital processing device 110 transmits a test pattern to the pluggable module 12 while changing the phase of one of the differential outputs of the transmitter 112 (S11). The test pattern is a repeat pattern that is low in speed in comparison with the transmission speed of an electric signal to be processed during practical use, and the monitor circuit 125 of the pluggable module 12 may be formed from a small size semiconductor device.

The processor 130 extracts pulse width information as a function of the phase from a phase comparison result of the test pattern received by the pluggable module 12 (S12). Then, the processor 130 determines an inclination provided by extraction values and calculates a phase difference with which the value of the pulse width information is minimized (S13). For example, a line segment of a negative inclination along which, when the phase of one of the differential signals is changed, the value of the pulse width information decreases and another line segment of a positive inclination along which, when the phase of the one of the differential signals is changed, the value of the pulse width information increases from the minimum value are presumed, and the value of the pulse width information is minimized at a point of intersection of the two line segments. The phase difference between the P and N signals at this time is a phase set value optimum to the pluggable module 12.

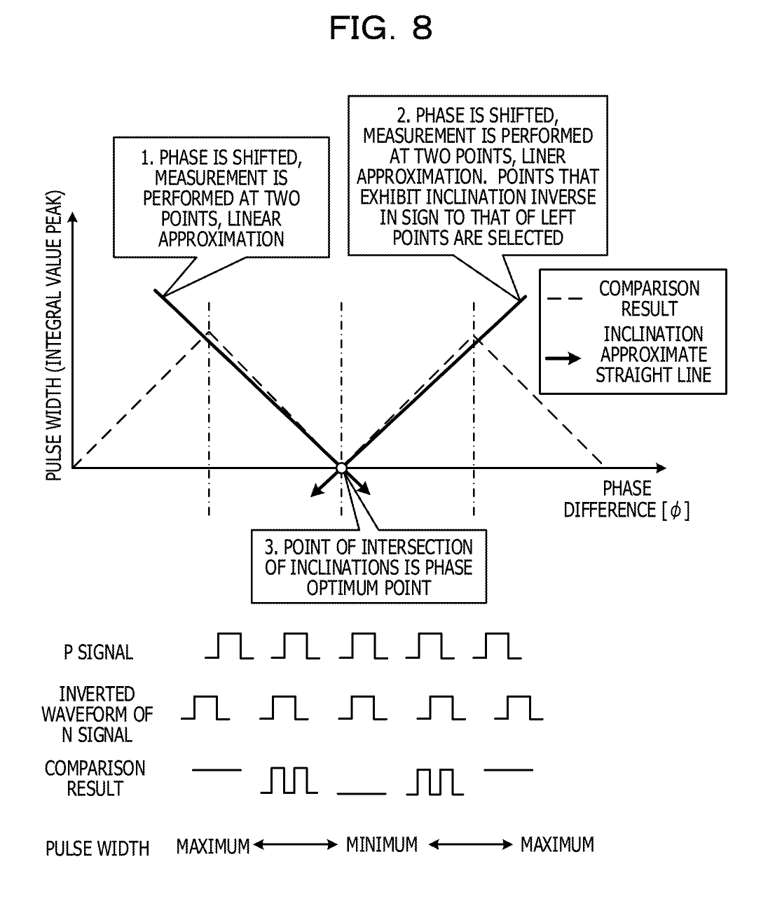

FIG. 8 depicts an example of calculation of a phase optimum value at step S13 of FIG. 7. The phase of one of the differential signals (for example, of the P signal) is fixed while the phase of the other one of the differential signals (for example, of the N signal) is changed. If the phase of the P signal and the phase of the inverted signal of the N signal match each other as seen in the middle of a lower view in FIG. 8, the comparison result of the comparator 123 indicates the low level. At this time, the pulse width detected from an AC component of the output of the comparator 123 is the minimum.

If the phase of the N signal is advanced with respect to the P signal (change in the leftward direction from the center in the lower view in FIG. 8), a plurality of pulses of a small width are detected as a result of the comparison between the inverted signal of the N signal and the P signal. If the phase of the N signal is advanced by up to n (half cycle) with respect to the P signal, the output from the comparator 123 is the maximum and the detected pulse width is the maximum. If the pulse width information (for example, an integral value peak) is acquired and plotted with a phase (φ) at two or more points, such a result as depicted in an upper view in FIG. 8 is obtained and the inclination of a line given by the plotted points is negative. If the phase of the N signal is further advanced from n, the pulse width gradually decreases, and the phase of the N signal and the phase of the P signal come to overlap with each other at 2n (one cycle).

If the phase of the N signal is delayed with respect to the P signal (change in the rightward direction from the center in the lower view in FIG. 8), a plurality of pulses of a small width are detected as a result of the comparison between the inverted signal of the N signal and the P signal. If the phase of the N signal is delayed by up to n (half cycle) with respect to the P signal, the output from the comparator 123 becomes the maximum and the detected pulse width becomes the maximum. If the pulse width information (for example, an integral value peak) is acquired and plotted with a phase (φ) at two or more points, such a result as depicted in the upper view in FIG. 8 is obtained and the inclination of a line given by the plotted points is positive. If the phase of the N signal is further delayed from n, the comparison result gradually decreases, and the phase of the N signal and the phase of the P signal come to overlap with each other at 2n (one cycle).

The phase at a point of intersection between two approximate line segments is an optimum phase value. The optimum phase value may not necessarily be a phase difference zero at the transmitter 116. This is because, since there is an influence of a phase difference caused between differential signals by a connector or a wiring line, distortion compensation is performed such that the P/N skew is minimized when the differential signals are received by the pluggable module 12. The phase value at the point of intersection may be calculated from two approximate equations. Since the point of intersection is determined by calculation, even in the case where the sensitivity of the comparator 123 is low, an optimum phase point may be determined accurately. Although a small-sized inexpensive comparator sometimes fails to detect the phase difference when the phases of the P signal and the N signal approach each other, by determining approximate equations from pulse widths at least at two phase points at which the phase difference may be detected definitely and determining a point of intersection based on the approximate equations, an optimum phase point may be specified accurately and easily.

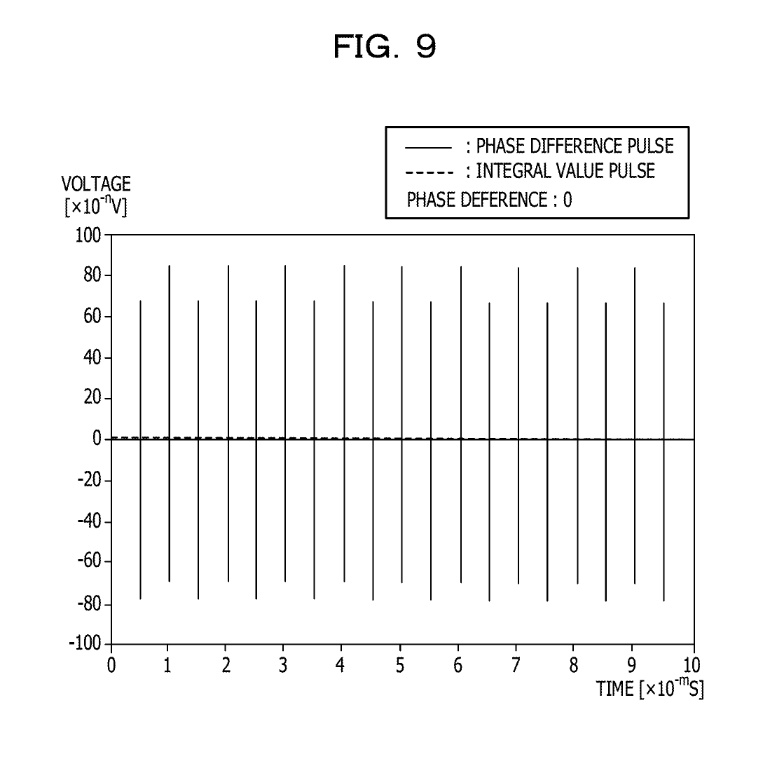

FIGS. 9 to 11 depict phase difference pulses included in an output of the comparator 123 and integral value pulses of the phase difference pulses when different phase differences are applied to a P signal and an N signal. In FIGS. 9 to 11, the axis of ordinate is a voltage (arbitrary unit) and the axis of abscissa is time (arbitrary unit). As an example, it is assumed that the unit of the voltage is ×10⁻ⁿ volt (V) and the unit of time is 10^{-m} second (S). n and m are integers and may be equal to or different from each other. For a test pattern, a rectangular pulse is used. The cycle of the test signal is 1. A solid line indicates a phase difference pulse, and a broken line indicates a time integral value waveform of the phase difference pulse. When the phase difference between the P signal and the N signal is zero in FIG. 9, the pulse width of the phase difference pulse is zero. Also the time integral value of the phase difference pulse is zero.

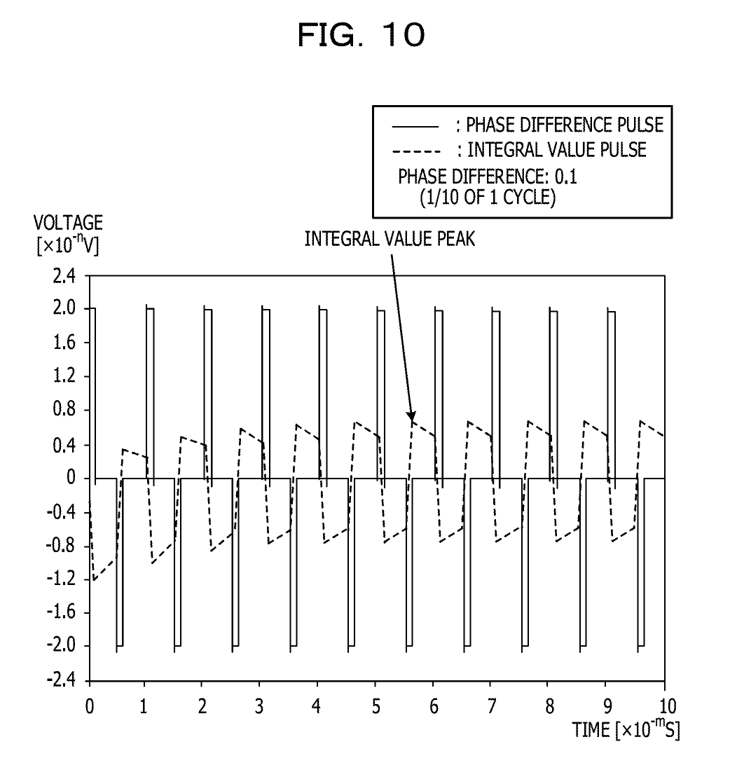

If a phase difference of 0.1 ( 1/10 of the cycle) is given in FIG. 10, thin pulses that are reversed in sign after every 0.5 cycle (one half cycle) are detected. The waveform of the time integral value of the phase difference pulse indicates maximum and minimum values that are not fixed values but indicate inclinations as indicated by a broken line. Therefore, a peak value of an edge having the highest voltage value is detected as an integral value.

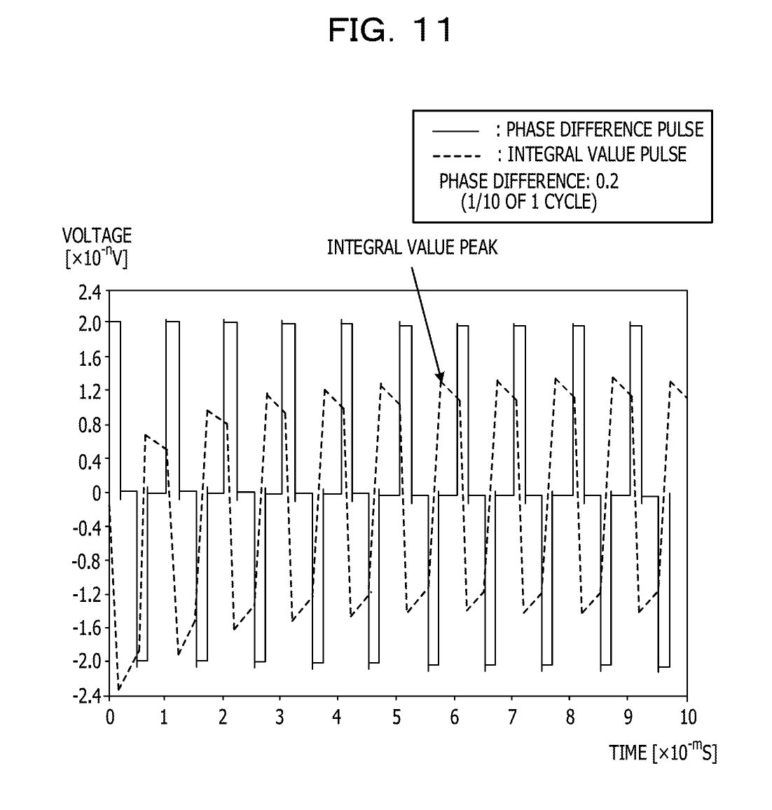

If a phase difference of 0.2 ( 2/10 of the cycle) is given in FIG. 11, the phase difference pulses that are reversed in sign after every one half cycle are detected similarly as in FIG. 10. However, the pulse width of the pulses is greater than that in FIG. 10. Also the amplitude of the waveform of the time integral value of the phase difference pulses is greater. The maximum and minimum values of the time integral value pulse are not fixed values but indicate inclinations. Thus, similar to FIG. 10, a peak value of an edge having the highest voltage value is detected as an integral value.

In the following, if the phase difference is increased by 0.1 cycle, the pulse width of the phase difference pulse increases and also the peak value of the integral value pulse increases. At the phase difference of 0.5 cycles (half cycle), the pulse width of the phase difference pulse and also the integral value peak become the maximum, and thereafter, they gradually decrease until both the pulse width of the phase difference pulse and the peak value of the integral value become the minimum at the phase difference of one cycle.

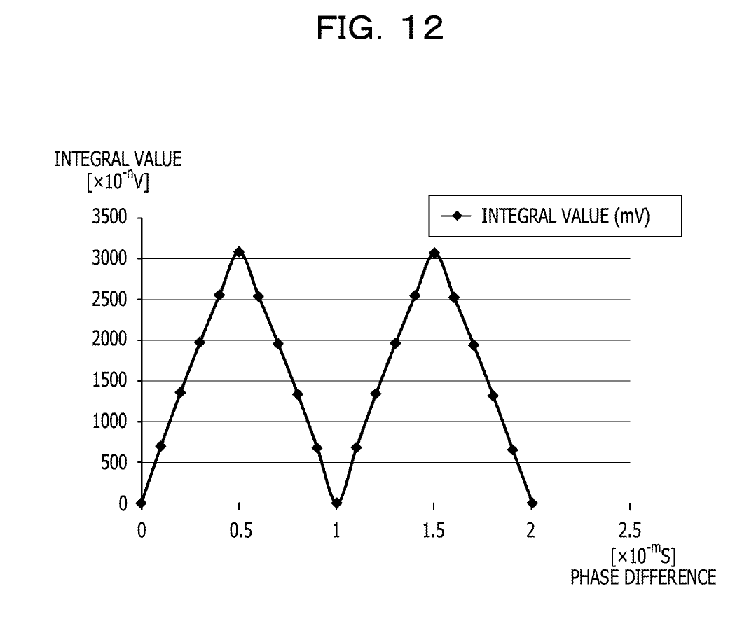

FIG. 12 is a view in which an integral value of a phase difference pulse is plotted as a function of a phase difference. In this example, the phase of the P signal is fixed while the phase of the N signal is changed in a same direction. When the phase difference between the P and N signals is 0, the P signal and the N signal inputted to the monitor circuit 125 are just opposite to each other in phase. At this time, the peaks of the pulse width of the phase pulse and the time integral value are zero, and the P/N skew is the minimum. As the phase difference increases, the integral value of the phase difference pulse increases (pulse with increase) and indicates a maximum value at the phase difference of 0.5 cycles (one half cycle). As the phase difference is further increased, the integral value (and pulse width) decreases, and at the phase difference of one cycle, the P signal and the N signal indicate the opposite phases to each other again and the P/N skew is minimized. Similar variations are observed also where the phase difference is within the range of one cycle to two cycles.

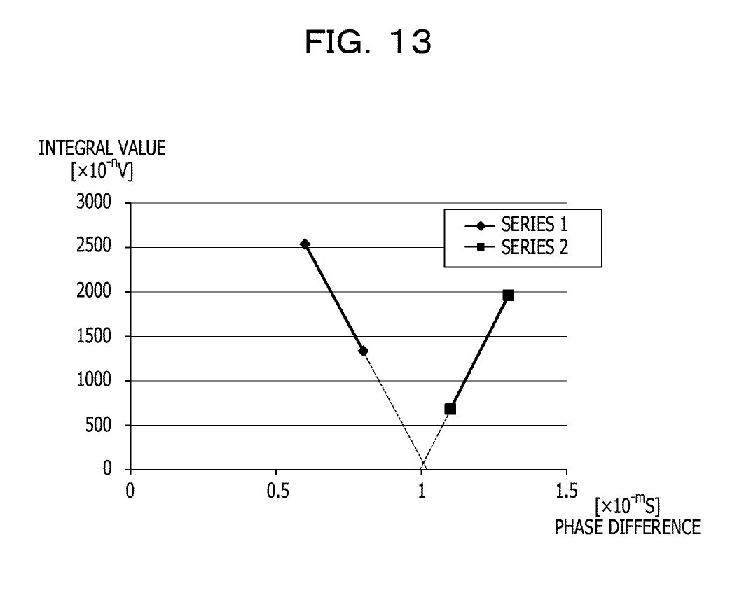

FIG. 13 depicts an inclination of integral values (peak values) between two points when a phase difference is changed. A series 1 indicates monitoring points with which a negative inclination is provided, and a series 2 indicates monitoring points with which a positive inclination is provided. A straight line may be approximated by taking a phase difference pulse width or a peak value of a time integral value of the phase difference pulse width at least at two phase points in a certain changing direction. Another straight line may be approximated by taking a phase difference pulse width or a peak value of a time integral value of the phase difference pulse width (hereinafter referred to suitably as “integral peak value”) at least at two phase points in the reverse changing direction. The phase value at a point of intersection between the two straight lines is an optimum phase value between P and N.

As the monitoring points, it is preferable to use two points that may be easily approximated linearly. If two points in the proximity of a point of intersection are selected, the pulse width (or the integral peak value) of the phase difference pulse is small, and an error is likely to occur. Preferably, phase points with which a phase difference pulse of a pulse width having a certain size is obtained are used. In the case where the phase of one of differential signals is changed in a same direction, for example, as depicted in FIG. 13, one straight line having a negative inclination is approximated with 6/10 cycles and 8/10 cycles, and another straight line having a positive inclination is approximated with 11/10 cycles and 13/10 cycles.

This technique is an example for determining an optimum phase, and the technique for such determination is not limited to this example. For example, linear approximation may be applied based on three or more pulse width measurement values. As a method of selection of phase points, after the phase difference is first changed by one half cycle or more to select two points ( 6/10 cycles and 8/10 cycles), two different points obtained by adding a phase difference of one half cycle to the two selected points (for example, 11/10 cycles and 13/10 cycles) may be selected. In the case where the phase of one of differential signals is changed in the positive direction and the negative direction, for example, after one straight line having a negative inclination is approximated with phased differences of − 3/10 cycles and − 1/10 cycle, n (one half cycle) may be added to each of the phase points to approximate one straight line having a positive inclination with phase differences of + 2/10 cycles and + 4/10 cycles.

A phase range from which two inclinations are to be acquired may be determined in advance. For example, an integral value peak value of a phase difference pulse may be measured, with a given phase amount 0 as a center, at least at two points within a phase range of 0 to −½ cycle (−n) and at least at two points within a phase range of 0 to +½ cycle (+n). In the case where the direction of phase change is one direction, a measurement value may be acquired at least at two points within a phase range of ½ cycle to one cycle of the phase difference and at least at two points within a phase range of one cycle to 3/2 cycles.

### Working Example 1

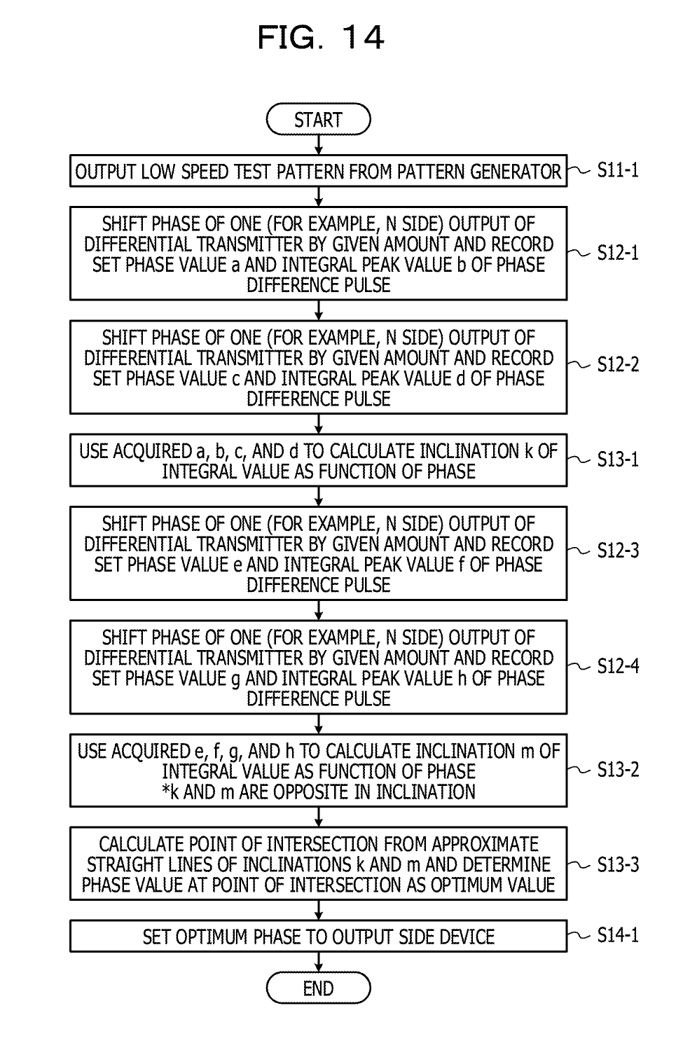

FIG. 14 depicts an example of a processing flow. A low speed test pattern is outputted from the pattern generator 111 (S11-1). The phase of one of differential outputs (for example, the N output) of the transmitter 116 is shifted by a given amount to set a phase value a, and then the set phase value a and an integral peak value b of a phase difference pulse obtained from a phase comparison result are recorded (S12-1). The N side output phase of the transmitter 116 is further shifted to a different value to set a phase value c, and then the set phase value c (a≠c) and an integral peak value d of the phase difference pulse at the time are recorded (S12-2). The acquired values a, b, c and d are used to calculate an inclination k provided by the phase difference pulse integral values (S13-1).

Thereafter, the N side phase of the differential transmitter 116 is further shifted to a different value to set a phase value e, and then the set phase value e and an integral peak value f of the phase difference pulse at the time are recorded (S12-3). As a selection method for the phase value e, e=a+T/2 (T is the cycle of the differential signal) or e=a+n radians may be applied. The N side phase of the transmitter 116 is shifted to a further different value to set a phase value g, and then the set phase value g (e≠g) and an integral peak value h of the phase difference pulse at the time are recorded (S12-4). As a selection method for the phase value g, g=c+T/2 (T is the cycle of the differential signal) or g=c+n radians may be applied. The acquired values e, f, g and h are used to calculate an inclination m of the phase difference pulse integral value (S13-2). The inclinations k and m are opposite in sign to each other.

From approximate straight line equations of the inclination k and the inclination m, a point of intersection of two line segments is calculated, and the phase value at the point of intersection is determined as an optimum value (S13-3). The optimum phase is set to a device on the output side and practical use is started (S14-1).

The carrying out order of the respective processes is not limited to that of the processes depicted in FIG. 14, and steps S13-1 to S13-3 may be performed after steps S12-1 to S12-4 are performed. This minimizes the P/N skew and makes it possible to optimize an electric signal waveform in response to a pluggable module used.

### Expansion Example

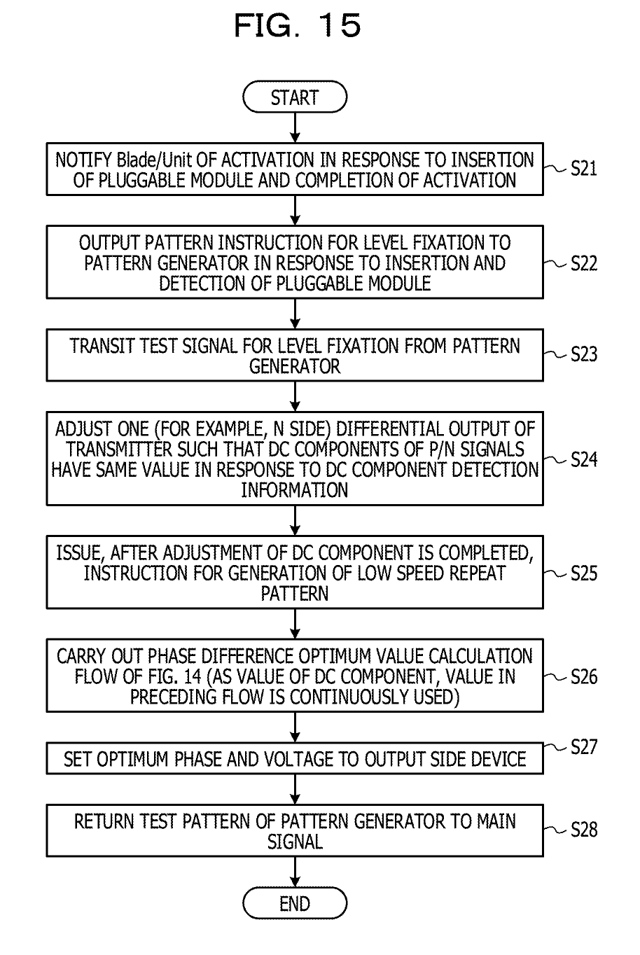

FIG. 15 depicts an example of a processing flow. In the embodiment described above, a test signal having a low speed repeat pattern is used to adjust the phase difference to minimize the P/N skew. In the expansion example, the amplitude (signal level) is controlled in addition to the phase to optimize the electric signal waveform with a higher degree of accuracy. For example, after the amplitude level is adjusted between P and N, the phases are adjusted.

After the pluggable module 12 is inserted and activation is completed, an insertion completion notification or an activation notification is sent to the blade 11, and the insertion of the pluggable module 12 is detected by the blade 11 side (S21). The overall controlling unit 134 outputs the insertion detection of the pluggable module 12 to the test pattern instruction unit 126. The test pattern instruction unit 126 outputs a pattern instruction for level fixation to the pattern generator 111 based on the insertion detection (S22). For example, an instruction to fix the signal level to the logic level “1” is outputted.

The pattern generator 111 outputs a test signal whose level is fixed to the transmitter 112. The transmitter 112 generates an inverted signal and transmits the differential signals (S23). The amplitudes of the differential signals are compared with each other by the monitor circuit 125 of the pluggable module 12. Similarly to a low speed repeat test pattern, the comparator 123 compares the voltage level of the inverted signal of one of the differential signals (for example, of the N signal) and the voltage level of the other one of the differential signals with each other and inputs a result of the comparison to the DC component detector 141.

A detection result of the DC component detector 141 is supplied to the DC information acquisition unit 131 and is inputted to the overall controlling unit 134. The overall controlling unit 134 calculates, based on DC component detection information, a correction value such that the DC components may have an equal value between P and N and outputs the correction value to the equalizing controlling unit 135. The equalizing controlling unit 135 adjusts the voltage level of one of the differential outputs (for example, of the N side output) of the transmitter 116 based on the correction value (S24).

After the adjustment of DC components between P and N is completed, the overall controlling unit 134 notifies the test pattern instruction unit 136 of the start of phase adjustment. The test pattern instruction unit 136 issues an instruction for generation and outputting of a low speed repeat pattern in place of the level fixation pattern to the pattern generator 111 (S25). Thereafter, the calculation flow for a phase difference optimum value depicted in FIG. 14 is performed (S26). The calculation of the phase difference optimum value is performed in a state in which the signal voltage level is adjusted between P and N of the differential signals received by the pluggable module 12.

The phase with which the P/N skew is minimized is set to the differential signals by the process at step S26, and a voltage with which the DC level is adjusted between P and N is set by the process S24 (S27). After the phase and the voltage are set to respective optimum values, the test pattern of the pattern generator is changed over to the main signal to start operation (S28).

By this method, an electric signal having an appropriate amplitude level and having an appropriate waveform that minimizes the P/N skew may be outputted irrespective of the type of the pluggable module 12. Every time a pluggable module is exchanged, phase/amplitude adjustment optimum to the pluggable module is performed. Although specification may change depending upon insertion or removal even of a same pluggable module, every time a pluggable module is inserted, optimization of the pluggable interface is performed.

Although a specific working example is described above, the present technology is not limited to the example described. A configuration and a technique for pluggable interface optimization of the present technology may be applied to a pluggable module that is coupled to the client side such as a router or the like, and besides, to a case in which a coherent module to be coupled to the network side does not have a distortion compensation function for an electric waveform.

Further, optimization of the pluggable interface of the embodiment may be applied to a transponder, and besides, to an arbitrary signal transmission and reception apparatus. For example, the optimization may be applied to waveform distortion compensation for an electric signal that is to be transferred between an integrated circuit (IC) chip of a blade server and an optical transceiver module coupled to the blade server through a connector.

The processor 130 that is a control block and the digital processing device 110 may not necessarily be mounted on a same board, and at least one of them may be implemented by an external management unit or external software.

The pattern generator 111 may generate a low speed test pattern of a desired speed by generating a repeat pattern in which “1” and “0” are outputted repeatedly (normal speed), another pattern in which “1100” is repeatedly outputted (½ speed), a further pattern in which “11110000” is repeatedly outputted (¼ speed) or the like.

By acquiring an increased number of phase points to perform linear approximation in calculation of an optimum phase, the accuracy in optimum value calculation may be improved. An optimum phase value may be determined by solving a determinant in place of calculating an inclination provided by measurement values (pulse width information) using an approximate expression.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transmission and reception apparatus, comprising:
a processor; and
a processing device coupled to the processor, wherein
the processor is configured to:
detect insertion of a pluggable module,
issue, when the insertion of the pluggable module is detected, an instruction to the processing device to generate a first test signal to be supplied to the pluggable module;
extract an alternating current component from a first monitoring result of the first test signal by the pluggable module and acquiring pulse width information at a plurality of phase points; and
set a phase point determined based on the pulse width information as an optimum phase value to the processing device.

2. The transmission and reception apparatus according to claim 1, wherein the processing device outputs a first test signal of a lower speed than a transmission speed upon practical use to the pluggable module while changing the phase of the first test signal.

3. The transmission and reception apparatus according to claim 1, wherein the processor determines a phase point at which the pulse width information indicates a minimum value as the optimum phase value.

4. The transmission and reception apparatus according to claim 3, wherein
the processing device differentially outputs the first test signal;
the first monitoring result is a phase comparison result of differential signals; and
the pulse width information indicates a minimum value when the phase comparison result is the minimum.

5. The transmission and reception apparatus according to claim 4, wherein the phase comparison result is a comparison result between the phase of one of the differential signals and the phase of a signal obtained by inverting the other of the differential signal.

6. The transmission and reception apparatus according to claim 1, wherein the processor:
determines a first approximate straight line having a first inclination from values of the pulse width information at least at two phase points and determines a second approximate straight line having a second inclination directed in an opposite direction to the first inclination from values of the pulse width information at least at two different phase points; and
determines a phase value at a point of intersection, which becomes a valley, between the first approximate straight line and the second approximate straight line as the optimum phase value.

7. The transmission and reception apparatus according to claim 1, wherein the processor:
determines a first approximate straight line having a first inclination from values of the pulse width information at least at two phase points and determines a second approximate straight line having a second inclination directed in an opposite direction to the first inclination from values of the pulse width information at phase points obtained by adding n radians or one half of a cycle of the first test signal to individual ones of the two phase points; and
determines a phase value at a point of intersection, which becomes a valley, between the first approximate straight line and the second approximate straight line as the optimum phase value.

8. The transmission and reception apparatus according to claim 4, wherein
the processing device:
transmits, when the insertion of the pluggable module is detected, a second test signal having a fixed voltage level to the pluggable module, and
the processor:
extracts a direct current component from a second monitoring result of the second test signal by the pluggable module to detect a level difference between the differential signals; and
sets a voltage value with which the level difference is minimized as an optimum voltage value to the processing device and causes, after the optimum voltage value is set, the processing device to output the first test signal of a low speed.

9. The transmission and reception apparatus according to claim 1, wherein the pulse width information is a peak value of a time integral value of a phase difference pulse included in the alternating current component.

10. The transmission and reception apparatus according to claim 1, wherein the processor changes over the output of the first test signal to an output of a main signal after the optimum phase value is set.

11. The transmission and reception apparatus according to claim 1, wherein the pluggable module is a client side interface or a network side interface of the transmission and reception apparatus.

12. An optical transmission apparatus, comprising:
a plurality of transmission and reception apparatus; and
an optical multiplexer/demultiplexer coupled to the plurality of transmission and reception apparatus,
wherein the plurality of transmission and reception apparatus each includes: a processor; and a processing device coupled to the processor,
wherein the processor is configured to:
detect insertion of a pluggable module,
issue, when the insertion of the pluggable module is detected, an instruction to the processing device to generate a first test signal to be supplied to the pluggable module;
extract an alternating current component from a first monitoring result of the first test signal by the pluggable module and acquiring pulse width information at a plurality of phase points; and
set a phase point determined based on the pulse width information as an optimum phase value to the processing device.

13. The optical transmission apparatus according to claim 12, wherein the processing device outputs a first test signal of a lower speed than a transmission speed upon practical use to the pluggable module while changing the phase of the first test signal.

14. The optical transmission apparatus according to claim 12, wherein the processor determines a phase point at which the pulse width information indicates a minimum value as the optimum phase value.

15. The optical transmission apparatus according to claim 12, wherein the processor:
determines a first approximate straight line having a first inclination from values of the pulse width information at least at two phase points and determines a second approximate straight line having a second inclination directed in an opposite direction to the first inclination from values of the pulse width information at least at two different phase points; and
determines a phase value at a point of intersection, which becomes a valley, between the first approximate straight line and the second approximate straight line as the optimum phase value.

16. The optical transmission apparatus according to claim 12, wherein the processor:
determines a first approximate straight line having a first inclination from values of the pulse width information at least at two phase points and determines a second approximate straight line having a second inclination directed in an opposite direction to the first inclination from values of the pulse width information at phase points obtained by adding n radians or one half of a cycle of the first test signal to individual ones of the two phase points; and
determines a phase value at a point of intersection, which becomes a valley, between the first approximate straight line and the second approximate straight line as the optimum phase value.

17. The optical transmission apparatus according to claim 12, wherein the processor changes over the output of the first test signal to an output of a main signal after the optimum phase value is set.

18. An optimization method for a pluggable interface, comprising:
detecting, by a processor, insertion of a pluggable module;
issuing, when the insertion of the pluggable module is detected, an instruction to a processing device coupled to the processor to generate a first test signal to be supplied to the pluggable module;
extracting an alternating current component from a first monitoring result of the first test signal by the pluggable module and acquiring pulse width information at a plurality of phase points; and
setting a phase point determined based on the pulse width information as an optimum phase value to the processing device.

19. The optimization method according to claim 18, further comprising:
outputting, by the processing device, a first test signal of a lower speed than a transmission speed upon practical use to the pluggable module while changing the phase of the first test signal.

20. The optimization method according to claim 18, further comprising:
determining a phase point at which the pulse width information indicates a minimum value as the optimum phase value.
